(19) United States
(12) Patent Application Publication
(10) Pub. No.: US 2012/0072315 A1
(43) Pub. Date: Mar. 22, 2012

(54) AGENT REFERRAL SYSTEM AND METHOD WITH INTEGRATED BUYER, LENDER, AND AGENT COMMUNICATION

(75) Inventors: Stephen M. Polston, Excelsior, MN (US); Aaron Matthew Vennie, Burnsville, MN (US); Jeffrey Matthew Colville, Maple Grove, MN (US); Michelle Patrice Hiller, Elk River, MN (US); Joan Marie Skallman, Excelsior, MN (US)

(73) Assignee: PREFERRED HOME BUYERS NETWORK, INC., Excelsior, MN (US)

(21) Appl. No.: 13/071,828

(22) Filed: Mar. 25, 2011

Related U.S. Application Data
(63) Continuation-in-part of application No. 12/768,137, filed on Apr. 27, 2010.
Application No. 12/768,137 is a continuation-in-part of application No. 11/999,299, filed on Dec. 4, 2007, now Pat. No. 8,095,457.
Application No. 11/999,299 is a continuation-in-part of application No. 11/403,385, filed on Apr. 12, 2006.
Application No. 11/403,385 is a continuation-in-part of application No. 10/187,207, filed on Jul. 1, 2002.
(60) Provisional application No. 61/214,781, filed on Apr. 28, 2009.
(60) Provisional application No. 60/359,804, filed on Feb. 26, 2002.

(51) Int. Cl. G06Q 50/16; G06Q 40/00

(52) U.S. Cl. 705/30; 705/313

(57) ABSTRACT

A computerized system and method are presented for allowing a real estate agent to directly enroll a buyer in a destination real estate market after referring the buyer to a receiving agent. After affirmation by the buyer, the system provides the buyer with listing information obtained through the MLS of the destination real estate market. The referring agent continues to participate in the buyer's real estate research through the system, while also being eligible to receive a referral fee paid by the receiving agent. The computerized system maintains a list of certified agents able to receive a referral. Only those agents that have contractually agreed to pay a referral fee for clients obtained from other agents through the system and who meet certain performance minimums in the system will be certified.

### RELATED APPLICATIONS

This application is a continuation-in-part of U.S. patent application Ser. No. 12/768,137 (the '137 application), filed on Apr. 27, 2010, which in turn claimed priority to U.S. Provisional Patent Application No. 61/214,781, filed on Apr. 28, 2009. The '137 application is also a continuation-in-part application of U.S. patent application Ser. No. 11/403,385, filed on Apr. 12, 2006, which is a continuation-in-part of U.S. patent application Ser. No. 10/187,207, filed on Jul. 1, 2002 and which itself claimed priority to U.S. Provisional Patent Application No. 60/359,804, filed Feb. 26, 2002. The '137 application is also a continuation-in-part application of U.S. patent application Ser. No. 11/999,299, filed on Dec. 4, 2007. Each of these related applications is hereby incorporated by reference.

### SUMMARY OF THE INVENTION

Real estate listing data is created by real estate agents and brokers when they obtain a listing. This data is then shared with other agents, brokers, and potential buyers through agreements with a multiple listing service. These multiple listing services also allow the sharing of this data with the public over the Internet subject to certain conditions.

One embodiment of the present invention allows a referring agent to directly enroll the buyer in another real estate market by using a computerized system to refer the buyer to a receiving agent. After the buyer affirms their relationship with the receiving agent, the system immediately provides the buyer with listing information obtained through the MLS of the receiving agent. The referring agent can continue to participate in the buyer's real estate research process using the system, while also being eligible to receive a referral fee. The buyer benefits by having access to the MLS data in the destination market without having to investigate and select a new real estate agent on their own. The receiving agent receives potential buyers through their willingness to meet performance criteria in the system and pay the referral fee. In some embodiments, the consumer being referred by the referring agent to the receiving agent may also be a seller of real estate instead of a potential purchaser.

In one embodiment, the computerized system will associate a potential buyer with a brokerage institution broker. In this way, the system can allow buyers to access listing data under common MLS rules. The brokerage institution may receive the referral fee paid by the receiving agent. This fee may be shared with the referring agent.

In one embodiment, the computerized system maintains a list of agents that have contractually agreed to pay a referral fee for clients obtained from other agents through the system. Only those agents that have contractually agreed to the referral fee arrangement and who meet certain performance minimums in the system will be certified. In another embodiment, the originating real estate agent works within the system with a single lender or loan officer. The system may limit the potential receiving agents to those agents in the destination area that are working with lenders affiliated with the referring lender. In another embodiment, a receiving lender is also assigned to the buyer if the referring lender is not able to make loans in the destination area.

The parties using the system can communicate with each other and monitor a buyer's use of the system. Specifically, the destination and referring loan officers and agents, along with strategic business sources, can communicate with the buyer through the system, track the buyer's use, and can share notes about the buyer with one another. Furthermore, contact details for these parties are shared with the buyer during use of the system.

### BRIEF DESCRIPTION OF THE DRAWINGS

FIG. 1 is a block diagram showing a computerized system in use with a buyer, an agent, a lender, and a strategic business source.

FIG. 2 is a block diagram showing the referral of a buyer from a referring agent to a receiving agent, along with related lenders and listing data.

FIG. 3 is a block diagram showing the relationship between a brokerage institution operating the computerized system and two institution brokers working with two multiple listing services.

FIG. 4 is a block diagram of the computerized system 10 in communication with the parties identified in FIG. 1.

FIG. 5 is a schematic representation of financial institution hierarchy.

FIG. 6 is a block diagram showing a server computer operating a web server to present interfaces over the World Wide Web.

FIG. 7 is a flow chart showing the referral process used by an embodiment of the present invention.

FIG. 8 is a flow chart showing the receiving agent assignment process used by an embodiment of the present invention.

FIG. 9 is a flow chart showing the receiving lender assignment process used by an embodiment of the present invention.

### DETAILED DESCRIPTION OF THE INVENTION

### Basic Configuration

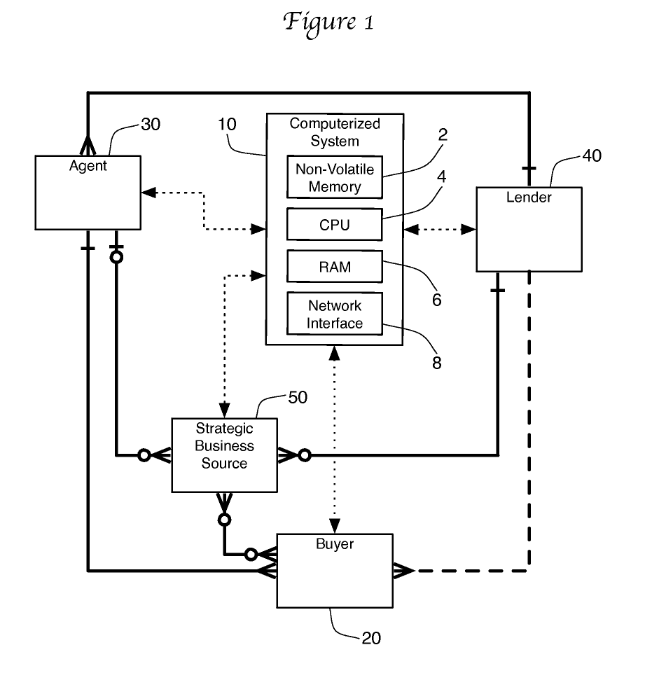

FIG. 1 is a block diagram showing a buyer 20, an agent 30, a lender 40, and a strategic business source 50 that are connected through a computerized system 10. The buyer 20 can include anyone generally interested in acquiring real estate, regardless of whether that person or entity will purchase or otherwise complete the real estate transaction. The agent 30 in the context of this disclosure is a representative or agent of the owner such as a real estate agent, or someone such as a buyer's representative who provides the buyer with the opportunity to purchase the real estate, or the like. A lender 40 is anyone who can provide access to funds, whether it is for debt or equity. Examples include banks, loan officers, venture capitalists, or the like.

A strategic business source 50 can be any party that may be of use to the buyer 20 in addition to the agent 30 and lender 40, such as a moving company. Alternatively, the strategic business source 50 may be any party who would be willing to recommend that buyers 20 participate in the system 10 with a particular lender 40 or a particular agent 30. In most circumstances, the strategic business source 50 is not another agent 30 or lender 40.

In the primary embodiment discussed below, the buyer 20 is a potential purchaser of real estate, the agent 30 is a real estate agent or a real estate broker, the lender 40 is a mortgage loan officer, and the strategic business source 50 is a party who is known by the buyer 20 or would be of use to the buyer 20. In some jurisdictions, a distinction is made between an agent who is licensed to sell real estate, and a broker who is allowed to operate their own real estate brokerage and hire additional agents to help sell real estate. Most MLS organizations require that their participants be real estate brokers, with agents subscribing to the MLS listing data through their relationship with a broker.

The computerized system 10 includes a set of software instructions and/or interfaces stored on a non-volatile, non-transitory, computer readable medium 2 for execution on a digital processor 4. The digital processor 4 is preferably a general purpose CPU, such as those manufactured by Intel or AMD. In the preferred embodiment, the computer program is stored on a tangible memory device 2, such as a hard drive or some form of non-volatile memory chip, which is electronically accessible by processor 4. To operate the software stored in memory 2, the software can be loaded by the processor 4 into faster, but volatile RAM 6. Data operated upon by the software can also be stored in non-volatile memory 2 and retrieved into RAM 6 for analysis, recording, and reporting. The computer system 10 further includes a network interface 8 to communicate with other computerized devices across a digital data network. In one embodiment, the network is the Internet, and the network interface 8 includes TCP/IP protocol stacks for communicating over the network. The network interface 8 may connect to the network wirelessly or through a physical wired connection. Instead of being a single computer with a single processor 4, the computerized system 10 could also be a network of computers all operating according to the instructions of the computer program.

The buyer 20, agent 30, lender 40, and strategic business source 50 preferably communicate with the computerized system 10 through a wide area network such as the Internet. This can be accomplished by using the computer program to operate a web server, which requires the buyer 20, agent 30, and lender 40 to access the program through a web browser operating on a local computer attached to the Internet. The buyer 20, agent 30, or lender 40 identify themselves to the web server through a log-in process, and the web server presents to the browser a interface that is specific to the user logging in.

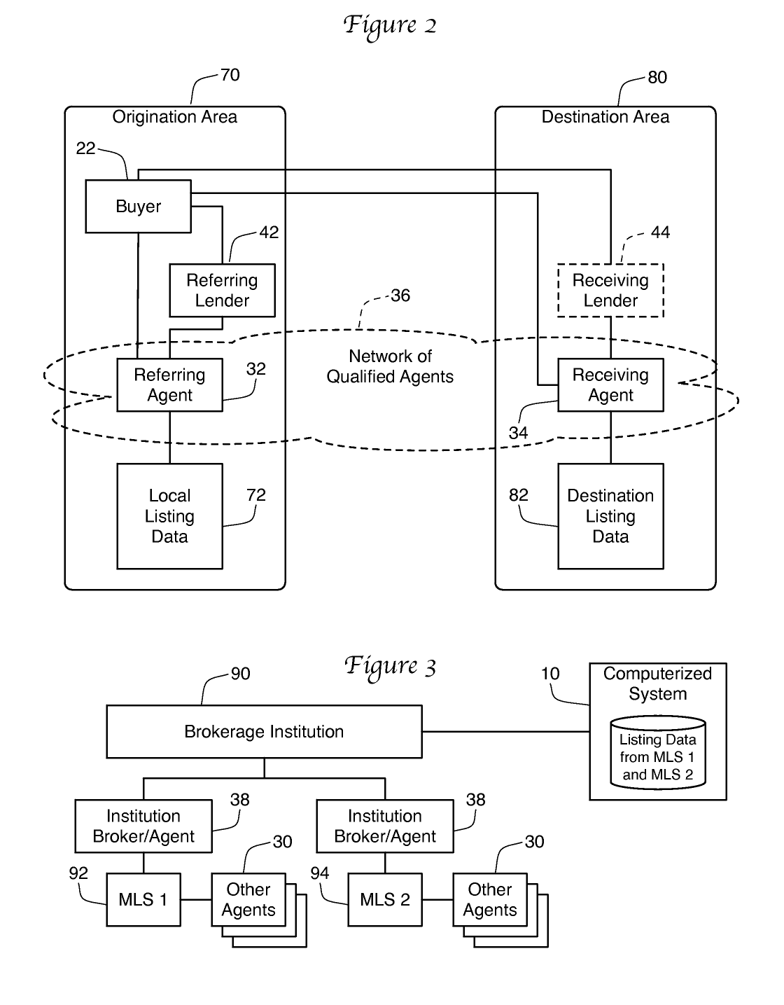

FIG. 1 also shows the associations or affiliations that are established between each of the parties 20-50. These affiliations are shown in thick, solid lines using the format normally used for entity relationship diagrams in database design. In one embodiment, each buyer 20 in the system is typically associated with a single agent 30 and a single lender 40, while the agents 30 and lenders 40 can be associated with multiple buyers 20. Each agent 30 in turn is often associated with a single lender 40, while a lender 40 is usually associated with multiple agents 30. Since each agent 30 using the system 10 is frequently associated with only a single lender 40, buyers 20 brought into the system 10 by such an agent 30 are automatically associated with that lender 40. While this association exists through the agent 30, the link between the buyer 20 and the lender 40 is shown directly as a dashed line in FIG. 1. In other embodiments, the buyer 20 can be associated with more than one agent 30 or lender 40, such as in the referral embodiment described below in connection with FIG. 2.

As for strategic business sources 50, it is not necessary for any strategic business sources 50 to be involved in the relationship between the buyer 20, seller 30, and lender 40. Consequently, FIG. 1 shows that it is always possible to have zero strategic business sources 50 associated with a party. Furthermore, it is possible for each buyer 20, seller 30, and lender 40 to be associated with multiple strategic business sources 50. In one embodiment, each strategic business source 50 can be affiliated with only a single lender 40.

### Referral Network of Qualified Agents

A buyer 20 may select an agent 30 for a variety of reasons—a family relationship with the agent 30, a widespread favorable reputation, or the recommendation of a friend. In some circumstance, the agent 30 that a buyer 20 desires to work with does not work in the geographic area where the buyer 20 is hoping to purchase a home. This issue can be seen in the schematic drawing of FIG. 2, in which a particular buyer 22 would naturally select agent 32 (the “referring agent”) to assist in their home purchase. The agent 32 is associated with a particular MLS that allows that agent 32 to share local listing data 72. While this listing data 72 contains properties that are listed for sale in a first geographic area (the “origination area”) 70, the buyer 22 actually desires to purchase property is in a second geographic area (the “destination area”) 80. If the buyer 22 were to simply select the agent 32 as their agent for the computer system 10 (and agrees to enter into a legal relationship with that agent 32), they would be granted access only to the origination area listing data 72.

In order to solve this dilemma, one embodiment of the present invention allows the referring agent 32 to refer their buyer 22 within the computerized system 10 to a receiving agent 34 that is associated with an MLS in the destination area 80. Once the referring agent 32 associates the buyer 22 in the computerized system 10 with the receiving agent 34, and the buyer agrees to that relationship, the buyer 22 can be granted full access to the destination listing data 82 in the computerized system 10. During this use, the referring agent 32 and the receiving agent 34 can communicate with the buyer through the system 10, and can share notes about the buyer 22 with one another. Furthermore, contact information about both the referring and the receiving agents 32, 34 are shared with the buyer 22 during use of the system 10.

In one embodiment, the receiving agent 34 is selected from a network of agents 36 maintained by the computerized system 10 that have contractually agreed to pay a referral fee to obtain clients from others in the system 10. In another embodiment, only those agents 34 that have contractually agreed to the referral fee arrangement and who meet certain performance minimums in the system 10 will be certified as part of the network 36 who can receive referrals.

In yet another embodiment, the referring real estate agent 32 works within the system 10 with a single referring lender or loan officer 42. If the lender 42 working with the referring agent 32 is authorized to make loans in the destination geographic area 80, the lender 42 remains the exclusive lender working with the buyer 22 in the system 10. If the referring lender 42 is not able to make loans in the destination area, a receiving loan officer 44 that can provide such loans is associated with the buyer 22 in the computer system 10. The destination lender 44 and the original lender 42 can communicate with the buyer through the system 10, and can share notes 13 about the buyer 22 with one another and with the referring and receiving agent 32, 34. Furthermore, contact information about both the referring and the receiving lenders 42, 44 are shared with the buyer 22 during use of the system 10.

The system 10 can select the receiving agent 34 and the destination lender 44 (if needed) based on pre-established criteria. The system 10 may select the receiving loan officer 44 based on the financial institution 60 that employs the referring loan officer 42. If that financial institution 60 has loan officers able to provide loans in the destination area 80, the system 10 will select a receiving lender 44 from that financial institution, and then select a certified receiving agent 34 working in the destination area 80 that is already associated in the system 10 with that receiving loan officer 44. If the referring lender 42 does not work with a financial institution 60 that can provide loans in the destination area 80, the system 10 may select any receiving loan officer that can provide such loans as the receiving lender 44.

In other embodiments, the system 10 does not select the receiving agent 34, but rather presents a list of qualified agents in network 36 for selection by an individual using the system 10 (such as the referring agent 32, the referring lender 42, the buyer 22, or a strategic business source 50). For instance, the referring agent 32 may be able to select a receiving agent 34 to receive the referral from a list of those agents working in the destination area 80 that work with a receiving lender 44 that is associated with the same financial institution as the referring lender 42. If no such agents exist, the system 10 may present the referring agent 32 with a list of all qualified agents in the network 36 that have access to the destination listing data 82. Once the referring agent 32 selects the receiving agent 34, the receiving lender 44 associated with the agent is also associated with the buyer 22. Upon the buyer 22 closing on a property in the destination area 80, the receiving agent 34 will pay a referral fee for the referral of buyer 22.

Yet another embodiment of the present invention is shown in FIG. 3. In this embodiment, the system 10 is operated by or for the benefit of a real estate brokerage institution 90. This brokerage institution 90 may be a corporation or other entity that has real estate brokerage capabilities across the country. In FIG. 3, these capabilities are provided by broker/agents 38 that work for or on behalf of the institution 90. It is not necessary that these institution brokers 38 be legal employees of the brokerage institution 90, only that they work on behalf of the institution 90. These institution brokers 38 are members of their local MLS organizations, such as MLS 1 (92) and MLS 2 (94) shown in FIG. 3. Other agents and brokers 30 who are also members of the MLS 1 (92) or MLS 2 (94) are also participants in the computerized system 30 even though they are not affiliated with the brokerage institution 90.

In one embodiment, the system 10 will always associate a buyer 20 with a brokerage institution broker 38 in order that the system 10 may allow buyers 20 to access the listing data provided under the MLS rules. In addition, the system 10 will also associate the buyer 20 with an agent 30 (i.e., the receiving agent 34) who will help the buyer 20 investigate and purchase real estate. This agent 30 may or may not work with the brokerage institution 90. In some cases, the institution brokers 38 serve both roles, and individually help the buyer with all aspects of the real estate purchase transaction. In order to ensure that the institution brokers 38 are sufficiently busy, the computerized system 10 may even show a preference for designating institution agents 38 as the receiving agent 34.

One benefit of having the computerized system 10 operating on behalf of a brokerage institution 90 is that the institution 90 is legally able to receive referral fees for the referral of the buyer 22 to the receiving agent 34. In one embodiment, the institution 90 receives the referral fee and shares a portion of the fee with the referring agent 32. In situations where there is no referring agent, the institution 90 is able to receive the entire referral fee.

Communications with the Buyer

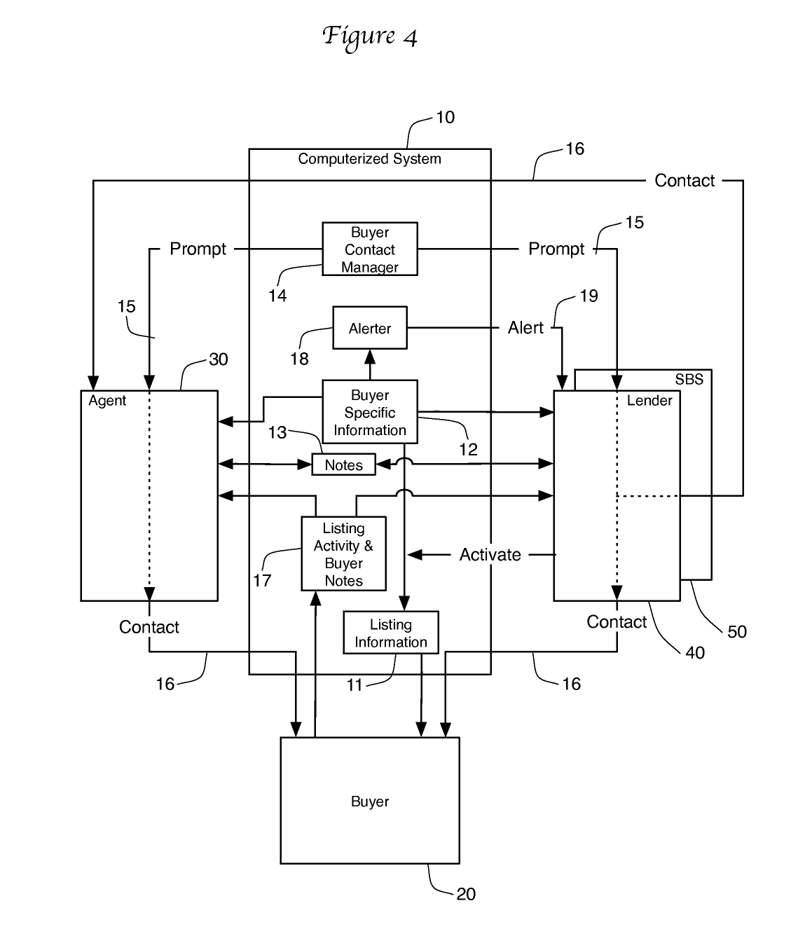

As explained in the patent applications that were incorporated by reference above, and as shown in FIG. 4, one of the benefits of the computerized system is the ability to provide real estate listing information 11 to the buyer 20 based upon buyer specific information 12 stored in the system 10. At the same time, the system 10 allows the seller 30 and the lender 40 to simultaneously monitor and assist the buyer 20 in his or her use of the system 10. For example, the seller 30 is able to correspond with the buyer 20, lender 40, and the strategic business source 50, through the computerized system 10. The seller 30 may also share notes 13 regarding the buyer 20 with the lender 40 and strategic business source 50. Similarly, the lender 40 and strategic business source 50 can contact the buyer 20 and seller 30 and share notes 13 with the seller 30. The buyer 20 can also use the system 10 to contact the seller 30, lender 40, or strategic business source 50 to ask questions or to provide information.

In order for the communication 16 with the buyer 20 to be relevant and useful to the buyer 20, the party 30, 40, 50 that is making the communication will need information about the buyer's current status in evaluating items. Consequently, the system 10 tracks activity information and buyer notes 17 concerning the properties that the buyer 20 reviews. The system 10 also allows the buyer 20 to store certain items or properties in a notebook for later review.

The buyer contact manager software 14 helps to manage these communications. In one embodiment, this software component 14 uses prompts 15 to encourage communication with the buyer 20 on a timely basis. By dividing the prompts between the various parties 30, 40, 50, the buyer contact manager 14 can ensure that the communications do not overwhelm the buyer 20. In the referral embodiment above, it is possible that the receiving agent 34 does not want to immediately participate in the communications with the buyer 22. For example, the buyer 22 might not be considered a “hot” prospect—i.e., their use of the system indicates that they are not nearing a purchase decision. In these cases, it is possible to design system 10 to avoid prompting any communications between the receiving agent 34 and the buyer 22 until the buyer's use of the system shows an increased likelihood of desiring to purchase a property in the near future. Alternatively, the communications could still be prompted, but only infrequently.

To ensure that the lender 40 and the buyer 20 communicate with each other, one embodiment of the system 10 does not allow the buyer 20 to utilize the system 10 until the lender 40 submits the buyer 20 to system 10 for activation. When new buyer specific information 12 is entered into the system 10, the alerter 18 sends an alert 19 to the lender 40 to notify the lender 40 that a new buyer 20 is awaiting activation. When a lender 40 logs into the system, a list of buyers 20 awaiting activation will appear, together with each buyer's corresponding agent 30 and any corresponding strategic business sources 50. The lender 40 will then determine whether to reject, amend or submit the buyer 20 for activation. This decision can be based on financial information related to the buyer 20, and the buyer's desired price range. The lender 40 can also amend the search criteria stored in the buyer specific information 12, such as raising or lowering the maximum price of the item based on the buyer's financial information. If the buyer 20 is accepted by the lender 40, the lender 40 will submit the buyer 20 for activation and await official activation of the buyer 20 by system 10.

In a referral situation shown in FIG. 2, there may be two lenders 42, 44 associated with the buyer 22. In this case, the system 10 can be designed to allow either or both of these lenders 42, 44 to submit the buyer 22 for activation. Alternatively, the system 10 could be designed to remove the requirement for activation by a lender 40 altogether. In one embodiment, the choice as to whether lender activation is required can be left up to the lender institution that engages the referring lender 42.

Once the buyer 20 is activated, the system 10 will generate item information 11 for the buyer 20 about items available for purchase, such as real estate listing information. The financial parameters established by the lender 40 can be used to control the properties available for search on the real estate listings database. If the buyer 20 wishes to increase this price point for any reason, the buyer 20 must request this change from the lender 40 as some embodiments prevent the buyer 20 from increasing the price point on their own.

### Financial Institution

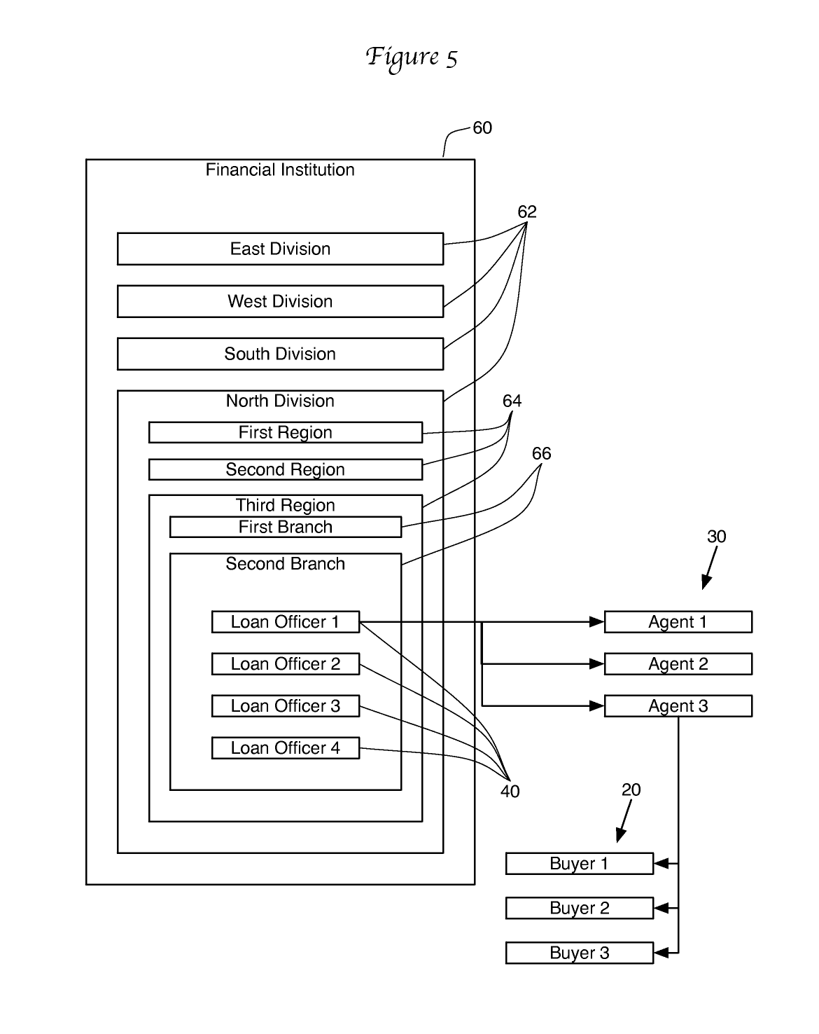

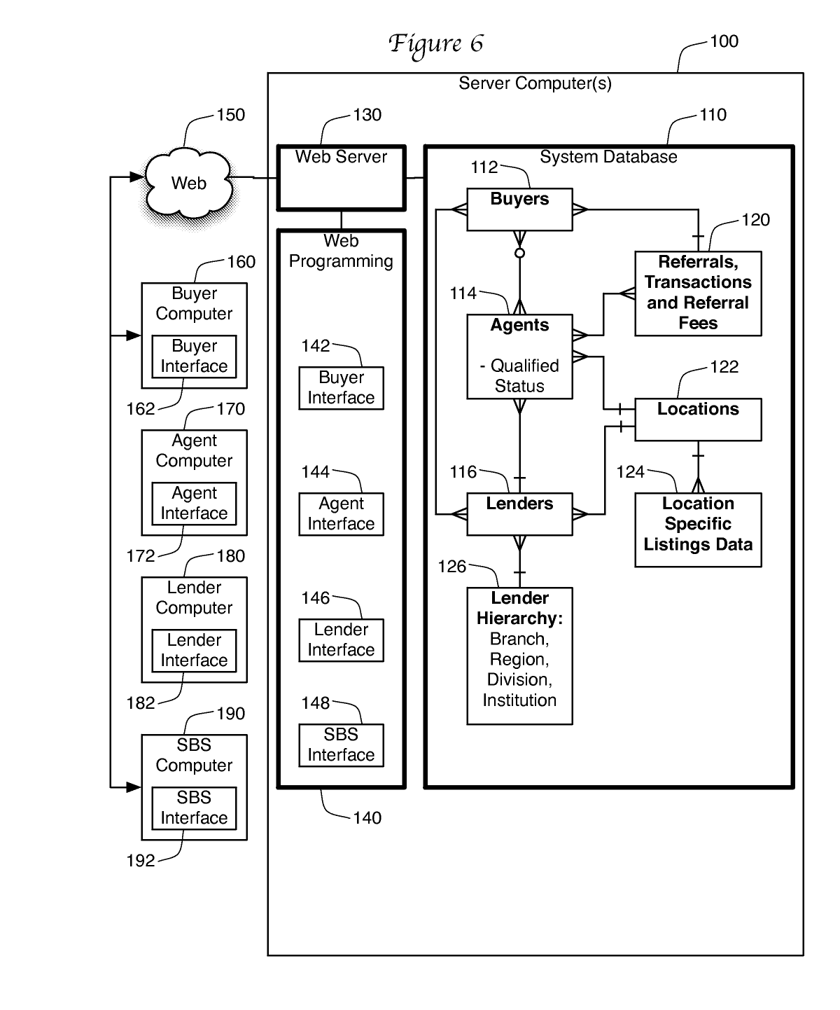

FIG. 5 shows a single financial institution 60 that has numerous lenders 40 within their organization that are using the system 10 simultaneously. This lender institution 60 is divided into a business hierarchy, which in this case divides the entire institution into four divisions 62. These four divisions 62 are each divided into separate regions 64. Each region 64 is likely to contain a plurality of branches or offices 66, with each branch 66 in turn employing a plurality of loan officers 40. In FIG. 5, Loan Officer 1 works for the Second Branch 66 of the Third Region 64 of the North Division 62 of the Lender Institution 60. This Loan Officer 40 works with three real estate agents 30. The third agent 30 (labeled “Agent 3” in FIG. 3) has signed up three buyers 20 to be associated with that agent 30 in the computerized system 10. Each of these three buyers 20 is also associated with Loan Officer 1 automatically by the system 10 as a result of the association maintained between agent 30 and loan officer 40.

### Implementation of System 10

The computerized system 10 is capable of storing information about all of the parties 20, 30, 40, 50 that use the system 10. In the preferred embodiment, this information is stored in a database 110 operating on one or more server computers 100, as shown in FIG. 6. The information stored about the parties 20, 30, 40, 50 can be set according to pre-defined fields in a database table (or database objects in an object-oriented database environment) within the database 110. FIG. 6 shows the database with tables or objects for buyers 112, agents 114, and lenders 116. Relationships between these entities 112-116 as well as the other entities in the database 110 are represented in FIG. 6 using crow's foot notation. It should be noted that FIG. 6 shows that it is possible for a buyer 112 in the database to be related to multiple agents 114 and multiple lenders 116 to reflect both referring agents 32 and lenders 42 as well as receiving agents 34 and lenders 44. It is also noted that the agent entity 114 includes a “qualified status,” indicating whether a particular agent is qualified to be part of the network of agents 36 that can receive referrals through the computerized system 10.

The database 110 can also keep track of referrals that have been made between agents 30 regarding particular buyers 20. In addition, the system is able to keep track of closed purchase transactions made by buyers 20 that have been the subject of referrals. This allows the system database 110 to also track referral fees that may be due as a result of these referrals. The tracking of referrals, transactions, and referral fees is shown as a single entity 120 in database 110. This should not be taken to indicate that this data would in fact be implemented as a single database table or object, but merely to indicate one or more database entities are created within database 110 to track this information. Furthermore, none of the entities shown within database 110 in FIG. 6 should be considered to show actual implementation details of the database 110, since it is well within the scope of the art to implement this type of data using a variety of entity architectures.

The database 110 also tracks specific geographic locations 122 serviced by the agents, and the location specific listing data 124 for each location 122. Furthermore, the database 110 stores information about the interrelationships between the lenders 40 and institutions 60 in the lender hierarchy 116.

The database 110 is used by a web server 130 operating on one or more of the server computers 100 to generate the various interfaces used by the system 10. In particular, web programming 140 exists that define how to create a buyer interface 142, an agent interface 144, a lender interface 146, and a strategic business source interface 148 using the data in the database 110. This programming 140 allows the web server 130 to transmit over the World Wide Web 150 a buyer interface 162 that can be seen by a browser operating on a computer 160 for the benefit of a buyer 20. Similarly, the web server 130 can manage an agent interface 172 on browser operating on an agent computer 170, a lender interface 182 on browser operating on a lender computer 180, and a strategic business source interface 192 operating on a strategic business source computer 190.

In the preferred embodiment, the type of information stored about each party 20, 30, 40 (i.e., the system “profile” for each party) is flexible, and can be varied depending on the needs of the users. For instance, a particular lender 40 (or lending institution) may wish to track particular information about their buyers 20 that is not desired by another lender 40. For example, one lender may wish to track a buyer's current interest rate on their existing mortgage loan for the purpose of future advertising campaigns, while another lender may not desire to track this information. The system 10 is flexible enough to allow these variations.

### Referral Process

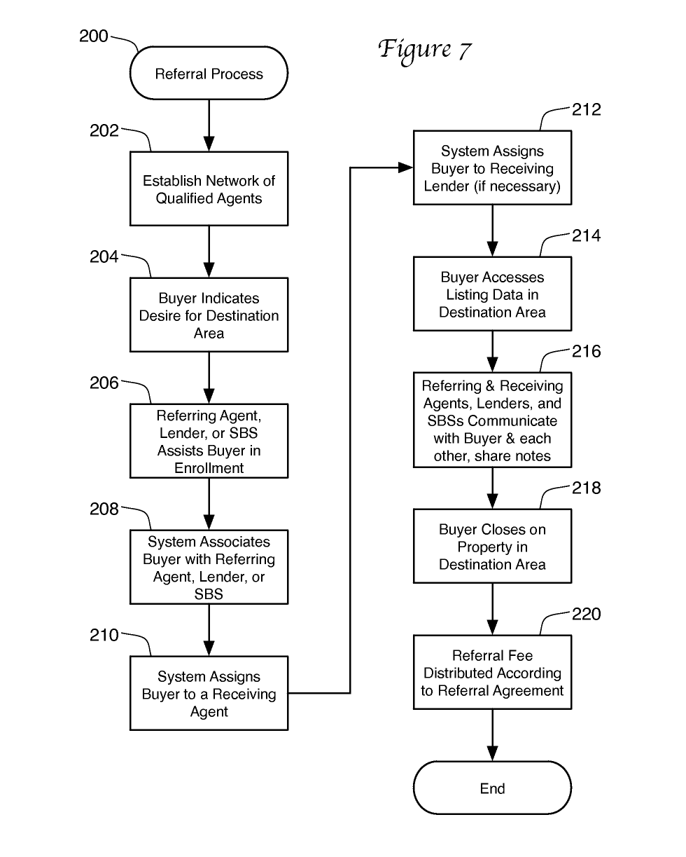

FIG. 7 shows a flow chart for the referral process 200 used by an embodiment of the present invention. This process 200 starts at step 202 by created a network 36 of qualified agents 30 that are able to receive referrals of buyers. In one embodiment, agents 30 in the system 100 are allowed to participate in the network 36 only when they have signed a written referral agreement. This referral agreement is a binding legal contract that requires that the receiving agent 34 share a portion of the commission they receive through a referred buyer 22 as a referral fee. In addition, the agents 34 may agree to meet certain performance requirements with respect to the use of the system 10, in particular as it relates to new referrals. For example, agents may agree to accept and contact referred buyers within a particular time period of the referral, to make timely contact with the buyer 22 when they receive prompts 15, and to keep current all of the relevant data within the database 110. If an agent 30 fails to meet these requirements, the agent 30 will not be selected as part of the network 36, or will be removed from the network 36.

At step 204, a buyer 22 in the referral process indicates a desire to search for real property in the destination area 80. In most cases, the buyer 22 indicates this desire to a referring agent 32, who may be a friend, relative, or another individual known to the buyer 22. This agent 32 serves as the entry for the buyer 20 into the system 10. This is true even though the agent 32 cannot assist the buyer 20 in the purchase of their desired real estate in the destination area 80. In some circumstances, the buyer 20 turns not to a referring agent 32, but to another party using system 10 such as a lender 40 or a strategic business source 50. To allow for these circumstances, one embodiment of the invention allows any of an agent 30, a lender 40, or a strategic business source 50 to serve as the referring party. If the referring party is a lender 40, they are the referring lender 42 shown in FIG. 2 (the strategic business sources 50 are not shown in FIG. 2).

At step 206, a referring party such as agent 32 or lender 42 enrolls a buyer 22 into the system 10. The computerized system 10 then establishes at step 208 an association between the buyer 22 and the referring party (such as referring agent 32 or lender 42) in the database 110. If the referring party is a lender 42, there may not be a referring agent 32 per se. If the referring party is an agent 32, however, the system may automatically assign the lender that works with that agent 32 as the referring lender 42.

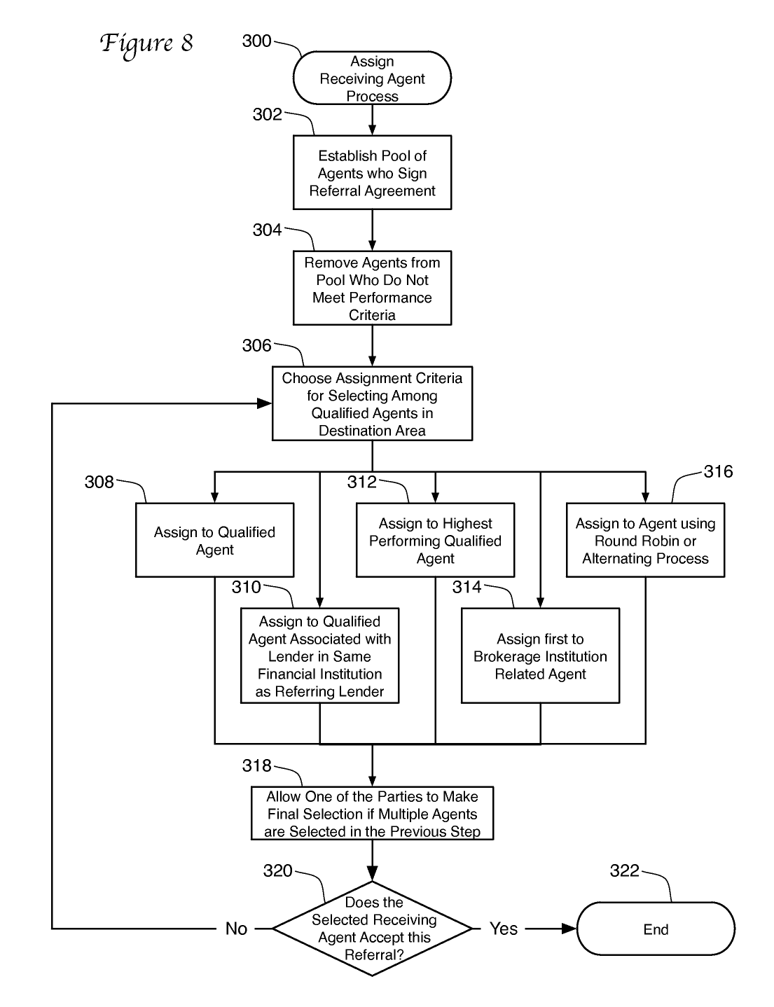

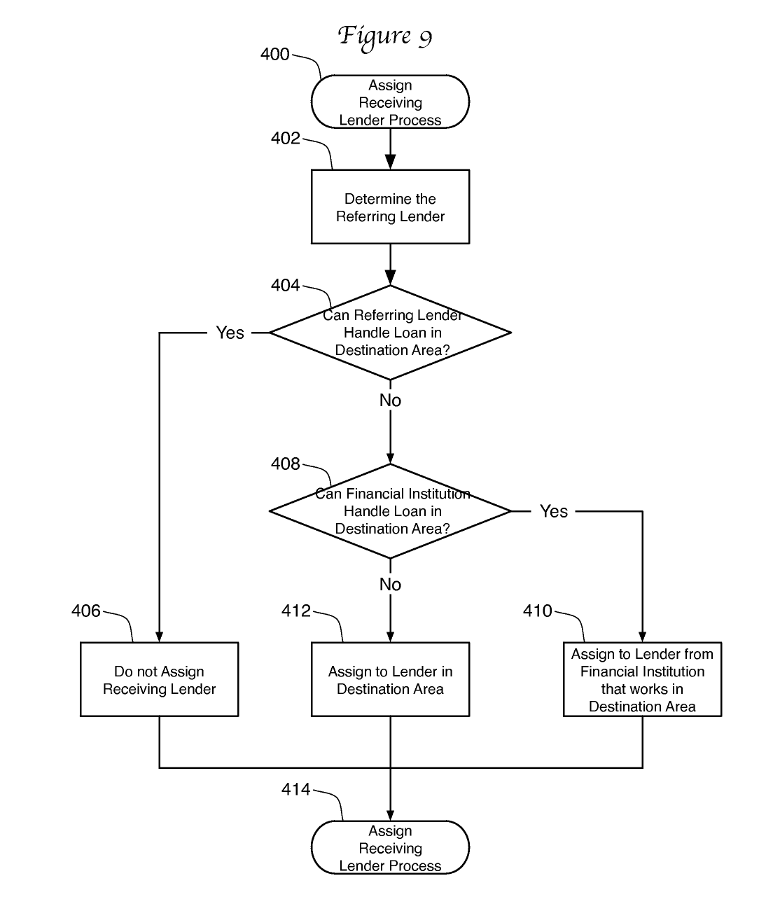

At step 210, the system assigns a receiving agent 34 for the destination area 80 to the buyer 22. In some embodiments, this assignment process is accomplished through a selection of the receiving agent 34 by the referring party from a plurality of agents in the referral network 36. In other cases, the system 10 may assign the institution broker/agent 38 that is working in the destination area 80 as the receiving agent 34. In still further cases, the receiving agent 34 is selected according to the financial institution 60 associated with the receiving lender 44 that is working with the receiving agent 34. The details of how the receiving agent 34 is assigned are described below in connection with FIG. 8. The system 10 also determines whether the referring lender 42 can handle the lending needs of the buyer 22 for the destination area 80. If not, a receiving lender 44 is assigned at step 212. This process is described in more detail in connection with FIG. 9.

Once the receiving agent 34 is associated with the buyer 22 and this is acknowledged by the buyer 22, the system 10 allows the buyer 22 to access the listing data 82 for the destination area 80 (at step 214). Alternatively, access to this information could be withheld until the receiving lender 44 initiates activation, as described above. At this time, the referring and receiving agent 32, 34, the referring and receiving lenders 42, 44, and any related strategic business sources 50 are able to communicate with each other and the buyer 22, and are able to share notes 13 entered into the system 10 about the buyer. The buyer contact manager software 14 can also prompt these parties to contact the buyer 22 according to its internal programming. This communication occurs at step 216.

When the buyer 22 closes on a property in the destination area 80, the receiving agent 34 will enter that data into the system 10 at step 218. In order to ensure that the system 10 is notified of real estate closings, the system 10 may also allow the buyer 22 to enter information about the closing. In fact, where allowed by local law some embodiments of the present invention will incentivize the buyer 22 to enter this information by offering a monetary reward or other gift after the buyer 22 notifies the system 10 that they have closed on a property using the assistance of the receiving agent 34.

Assuming the receiving agent 34 has received a commission on this sale, the referral agreement will require the receiving agent 34 to share a portion of that commission as a referral fee. In one embodiment, the management of the system 10 is performed by a brokerage institution 90 that is legally allowed to receive a referral fee. In these cases, the institution 90 will share the referral fee with the referring agent 32. In cases where there was no referring agent 32 (i.e., the buyer 22 was entered into the system 10 and referred to the receiving agent 34 by a lender 42 or a strategic business source 50), the brokerage institution 90 that manages the computerized system 10 will earn the entire referral fee.

In some embodiments, system 10 can track these referral fee payments, and can even initiate transfers of the referral fees to the appropriate bank accounts. In other cases, the payment of the referral fee takes place completely outside the computerized system 10, either through another automated process or through a manual process. In these other cases, the computerized system 10 may prompt the receiving agent 34 to pay the referral fee. The payment of this referral fee is accomplished in step 220 of FIG. 6. At this point, the referral process 200 is complete.

One process by which the receiving agent 34 can be selected and assigned to the system 10 in step 210 is shown in flow chart 300 in FIG. 8. The first two steps 302 and 304 of this process 300 is to establish the network 36 of potential receiving agents, and to actively monitor the network 36 to remove those agents 30 that do not meet the performance criteria described above. To enter the pool, an agent 30 must sign a referral commission agreement and attend training on use of the system 10. The monitoring step 304 allows the system 10 to remove any agent 30 from the network 36 who does not respond timely to referrals, maintain the database 110, or otherwise falls short of the minimum performance standards for the referral network 36.

The system 10 is designed so that multiple criteria can be used to select which agent 30 will be assigned as the receiving agent 34. The various criteria can be chosen by the financial institution 60 that pays for marketing opportunities provided by the system 10, and therefore could vary from situation to situation. Alternatively, the system 10 could be established to use only one of these criteria. Step 306 selects the appropriate criteria, and then implements the various criteria (seen in FIG. 8 as steps 308-318). In each case, these criteria 308-318 determine the subset of agents 30 that may be selected as the receiving agent 34. If more than one agent 30 meets that criteria, the system could let the referring agent 32 or the referring lender 42 select the receiving agent 34. Alternatively, the buyer 22 could be given the ability to select the receiving agent 34 from the available options. In some cases, the criteria 308-318 are designed to rank potential agents (such as by performance score in criteria 312 or last agent selected in criteria 316). In these circumstances, the criteria 308-318 ensure that only a single agent will be selected without the need for one of the parties to manually select the agent.

In step 308, the receiving agent 34 is selected from those agents 30 that are working with the MLS in the destination area 80, that met the minimum performance criteria in step 304, and that have entered into a binding referral fee agreement. In step 310, the receiving agent 34 is selected from those agents 30 who are associated with lenders 40 that work in the same financial institution 60 as the referring lender 42. In this step 310, it is not necessary for the lenders 40 to be formal employees of the financial institution 60, only that the lenders 40 have some formal relationship to the institution 60. In this way, the buyers 22 that had a relationship with a financial institution 60 before the referral will be able to maintain that relationship after the referral while working with the new receiving lender 44 and agent 34.

In step 312, the system 10 monitors the performance of agents 30 and lenders 40 using the system. A system that performs this type of monitoring is described in one of the co-pending application that was incorporated by reference above. The performance score would ideally indicate which agent 30 has performed in a way that would maximize the chance that a buyer 22 will use the agent 30 to close on the sale or purchase of real property. For example, the performance score might measure an agent's closing percentage, the agent's previous use the system 10 to communicate regularly with buyers, or even a customer satisfaction score. Step 312 scores this performance, and assigns the highest performing qualified agent as the receiving agent 34. Alternatively, step 312 could grade the agents 30 into a hierarchy, such as classes that are assigned a letter grade. Step 312 would first attempt to assign a “class A” agent 30 as the receiving agent 34. If no class A agents existed within the destination area 80, a class B agent 30 would be assigned.

In step 314, the system 10 gives preference to brokerage institution agents 38. This step 314 can be designed to provide a minimum workload to institution agents 38. If an agent 38 in the destination area 80 is below this workload, the system 10 can assign incoming referrals to that agent 38. If the agent 38 is above the minimum workload, the system 10 may instead rely upon one of the other processes 308-312, 316 for selecting a receiving agent 34.

In step 316, the system 10 alternates between qualified agents. The system 10 could use a straight round-robin technique, where every qualified agent is referred a buyer 22 in turn. Alternatively, this technique 316 could use a weighted system, giving preferences to some agents while still ensuring that all qualified agents eventually receive a referral of a buyer 22. For example, preferences could be given to brokerage institution brokers 38, or to agents 30 that score well under step 312.

Although these criteria 308-316 are shown as separate paths in the flow chart shown in FIG. 7, it would be well within the scope of this embodiment to combine multiple criteria together to select the receiving agent 34. For instance, the list of agents could be narrowed according to criteria 310, then further narrowed to require a performance cut-off score according to criteria 312, and then a single agent could be selected from the group based on the date of their last referral as determined by criteria 316.

In each of these steps 308-316, the system 10 might return a single agent as the receiving agent 34, or may return multiple agents. If necessary, step 318 allows an individual using the system (such as the referring agent 32 or lender 42, or a strategic business source 50) to select the receiving agent 34 from the list of qualified agents returned from these steps 308-314. Once a particular receiving agent is selected, that agent is given the opportunity to accept or decline the referral in step 320. If the agent rejects the referral, the process returns to step 306 to select another agent among the qualified agents in the destination area. If the selected receiving agent accepts the referral, the process of assigning a receiving agent ends at step 322. The system database 110 tracks the referral to a particular agent. However, only after the receiving agent 114 accepts the referral is the database 110 altered to associate the buyer 112 to the agent 114 in such a way as to allow the buyer 112 access to the location specific listings data 124 associated with the receiving agent's location 122.

FIG. 9 show a process 400 for assigning the receiving lender 44 (as discussed above at step 212). The first step 402 is to ascertain the identity of the referring lender 42. The referring lender 42 can be the lender who entered the buyer 22 into the system 10. Alternatively, the referring lender 42 can be the lender who is associated with the referring agent 32 or the referring strategic business source 50 who entered the buyer 22 into the system 10. It is possible that the buyer 22 entered their own data into the system 10, in which case there may be no referring lender 42.

The next step 404 is to determine whether the referring lender 42 can handle the loan for the buyer 22 in the destination area 80. If this is determined to be so, no receiving lender 44 is assigned (step 406) since the referring lender 42 can handle all of the duties of the receiving lender 44. If the referring lender 42 cannot handle the loan, step 408 determines whether the financial institution 60 for which the referring lender 32 works can handle the loan for the buyer 22 in the destination area 80. If so, another lender 40 who works with that financial institution 60 will be assigned as the receiving lender 44 in step 410. If not, or if there was no referring lender 42 determined in step 402, any lender 40 in the system that makes loans in the destination area 80 can be assigned to the buyer 22 at step 412. The process 400 ends at step 414.

The present invention has now been described with reference to several embodiments. The foregoing detailed description and examples have been given for clarity of understanding only. Those skilled in the art will recognize that many changes can be made in the described embodiments without departing from the scope and spirit of the invention. For example, the above description explains that a referring agent 32, lender 42, or strategic business source 50 can enter a buyer 22 into the system and initiate the referral to a receiving agent 34. It would be within the scope of the present invention to allow a buyer 22 to manually enter him or herself into the system without the help of a third party. The selection of the receiving agent 34 can still follow the logic of FIG. 8, with the referral fee in this case being earned completely by the brokerage institution 90 operating the system.

Because alternative embodiments are possible, the scope of the present invention should not be limited to the exact details and structures described herein, but rather by the appended claims and equivalents.

What is claimed is:

1. A computer product for allowing a referring agent who does not work in a destination location to refer a buyer to a receiving agent that works in the destination location, comprising:
a non-transitory computer readable medium having a computer program embodied therein, the computer program comprising
a) programming for managing a computerized database system that
i) associates the referring agent with a first location different than the destination location within the computerized database system; and
ii) associates the receiving agent and destination specific real estate listings data with the destination location within the computerized database system;
b) programming for creating a real estate agent interface that provides an interface for the referring agent to refer the buyer to the receiving agent;
c) programming for assigning the receiving agent to the buyer within the computerized database system after the referral; and
d) programming for creating a buyer interface that
i) withholds at least a portion of the destination specific real estate listings data from the buyer until the buyer is assigned to the receiving agent, and
ii) after assigning the buyer to the receiving agent, provides the withheld destination specific real estate listings data to the buyer.

2. The computer product of claim 1, wherein the real estate agent interface further provides an interface for the receiving agent to accept or reject the referral of the buyer.

3. The computer product of claim 2, wherein the referral is complete and the buyer is assigned to the receiving agent in the computerized database system only after the receiving agent accepts the referral.

4. The computer product of claim 3, wherein the real estate agent interface further notifies the referring agent whether the receiving agent has accepted or rejected the referral of the buyer.

5. The computer product of claim 4, wherein the real estate agent interface further provides an interface for the referring agent to refer the buyer to an alternative receiving agent.

6. The computer product of claim 3, wherein the buyer interface further provides an interface for the buyer to accept the referral to the receiving agent.

7. The computer product of claim 6, wherein the referral is complete and the buyer is assigned to the receiving agent in the computerized database system only after both the receiving agent and the buyer accept the referral.

8. The computer product of claim 1, wherein the first location and the destination location are defined by a geographic area selected from the set comprising zip code, city, county, state, and MLS area specified by a Multiple Listing Service.

9. The computer product of claim 1, further comprising programming that qualifies agents to become receiving agents, wherein the referring agent may only select qualified receiving agents to receive referrals.

10. The computer product of claim 9, wherein the programming for managing the computerized database system further tracks whether an agent has contractually agreed to pay a referral fee based on referrals, and further wherein only agents who have so contractually agreed may be qualified.

11. The computer product of claim 10, wherein the computer program further comprises programming for tracking sales of real estate and payments of referral fees based upon the sales of real estate, wherein the referral fee owed to the referring agent based on the referral of the buyer is tracked by the programming.

12. The computer product of claim 9, wherein the programming that qualifies agents determines whether the agents have met performance criteria.

13. The computer product of claim 12, wherein the performance criteria is chosen from the set of
i) accepting referrals within a set time period,
ii) making timely contact with the buyer, and
iii) keeping data current within the computerized database system.

14. The computer product of claim 1, wherein the computer program further comprises programming for selecting the receiving agent among a plurality of qualified agents based upon criteria selected from the set of:
i) determining which qualified agent has scored highest in a performance analysis based upon use of the computer program,
ii) determining a last qualified agent to have received a referral, and
iii) giving weighted priority to the qualified agent that works for a particular brokerage institution.

15. The computer product of claim 1, wherein the programming for managing a computerized database further associates the referring agent with a referring lender and associates the receiving agent with a receiving lender, and further wherein the computer program further comprises programming for selecting the receiving agent among a plurality of qualified agents based upon a relationship between the referring lender and the receiving lender within the computerized database system.

16. A computer product for allowing a referring agent who does not work in a destination location to refer a buyer to a receiving agent that works in the destination location, comprising:
a non-transitory computer readable medium having a computer program embodied therein, the computer program comprising
a) programming for managing a computerized database system that
i) associates the referring agent with a first location different than the destination location within the computerized database system; and
ii) associates a brokerage institution with a plurality of brokerage institution agents including a destination institution agent;
iii) associates the receiving agent, the destination institution agent, and destination specific real estate listings data with the destination location within the computerized database system;
b) programming for creating a real estate agent interface that provides an interface for the referring real estate agent to refer the buyer to the receiving agent,
c) programming for assigning the destination institution agent and the receiving agent to the buyer within the computerized database system after the referral;
d) programming for creating a buyer interface that
i) withholds at least a portion of the destination specific real estate listings data from the buyer until the buyer affirms a relationship with the destination institution agent, and
ii) after the buyer affirms the relationship with the destination institution agent, provides the withheld destination specific real estate listings data to the buyer.

17. The computer product of claim 16, wherein the receiving agent is one of the brokerage institution agents associated with the brokerage institution within the computerized database system.

18. The computer product of claim 16, wherein the receiving agent is not one of the brokerage institution agents associated with the brokerage institution within the computerized database system.

19. The computer product of claim 16, wherein the programming for managing a computerized database system further tracks payment of a referral fee from the receiving agent for the referral of the buyer, and further divides the referral fee between the brokerage institution and the referring agent.

20. The computer product of claim 16, wherein the computer program further comprises programming for selecting the receiving agent among a plurality of qualified agents based upon criteria selected from the set of:
i) determining which qualified agent has scored highest in a performance analysis based upon use of the computer program,
ii) determining a last qualified agent to have received a referral, and
iii) giving weighted priority to the qualified agent that works for the brokerage institution.

21. A computerized method for allowing a referring agent to refer a buyer to a receiving agent, the method comprising:
a) establishing a computerized database system stored on a tangible, non-transitory computer readable medium that associates
i) the referring agent to a first location,
ii) the receiving agent to a second location different than the first location, and
iii) destination specific real estate listings data with the second location;
b) withholding, through a server computer system, at least a portion of the destination specific real estate listings data in the computerized database system from a computerized buyer interface used by the buyer;
c) assisting in selection of the receiving agent by tracking, within the computerized database system, performance related information concerning a plurality of agents qualified to receive the referral;
d) receiving, at the server computer system, a referral to the receiving agent from a computerized agent interface used by the referring agent and tracking that referral for later calculation of a referral fee;
e) obtaining, at the server computer system, confirmation that the buyer has agreed to a brokerage relationship with the receiving agent;
f) ceasing to withhold the destination specific real estate listings data at the server computer system after receiving the confirmation; and
g) tracking within the computerized database system an obligation to pay the referral fee upon a sale of real estate to the buyer using services of the receiving agent and assigning at least a portion of the referral fee to the referring agent.
